(19) United States
(12) Patent Application Publication
(10) Pub. No.: US 2012/0200184 A1
(43) Pub. Date: Aug. 9, 2012

(54) RELATIVE DRIVING DEVICE, MOVING VEHICLE, AND ROBOT

(75) Inventor: Kesatoshi TAKEUCHI, Shiojiri (JP)

(73) Assignee: SEIKO EPSON CORPORATION, Tokyo (JP)

(21) Appl. No.: 13/367,631

(22) Filed: Feb. 7, 2012

(30) Foreign Application Priority Data
Feb. 8, 2011 (JP) 2011-024584

(51) Int. Cl. H02K 7/20

(52) U.S. Cl. 310/112

(57) ABSTRACT

A relative driving device includes a stator; a first rotor; and a second rotor, in which the stator includes a first electromagnetic coil and a first control unit that controls current supplied to the first electromagnetic coil, the first rotor includes a first magnet and a second magnet, the second rotor includes a second electromagnetic coil and a second control unit that controls current supplied to the second electromagnetic coil, the first electromagnetic coil and the first magnet are disposed so as to face each other to form the first driving mechanism, and the second electromagnetic coil and the second magnet are disposed so as to face each other to form the second driving mechanism.

### BACKGROUND

1. Technical Field

The present invention relates to a device for driving two driving force transmission members relative to each other using electrical energy.

2. Related Art

Various transmission systems are known as devices for driving two driving shafts relative to each other (for example, see JP-A-2001-124163).

However, transmission systems of the related art can transmit driving force in only one predetermined direction from one driving shaft (first driving shaft) to the other driving shaft (second driving shaft). Moreover, in order to recover electrical power by so-called regeneration, it is necessary to provide separate motors. Furthermore, since the rotation speed of a motor is generally determined by a driving voltage, it is necessary to increase the driving voltage in order to rotate the motor at a high speed.

### SUMMARY

An advantage of some aspects of the invention is that it provides a relative driving device employing a system that is different from that of the related art.

### Application Example 1

This application example of the invention is directed to a relative driving device including a first driving mechanism and a second driving mechanism, including: a stator; a first rotor; and a second rotor, wherein the stator includes a first electromagnetic coil and a first control unit that controls current supplied to the first electromagnetic coil, wherein the first rotor includes a first magnet and a second magnet, wherein the second rotor includes a second electromagnetic coil and a second control unit that controls current supplied to the second electromagnetic coil, wherein the first electromagnetic coil and the first magnet are disposed so as to face each other to form the first driving mechanism, and wherein the second electromagnetic coil and the second magnet are disposed so as to face each other to form the second driving mechanism.

According to this application example, a relative driving device can be configured so that one driving device includes the first and second driving mechanisms. Therefore, the rotor of the first driving mechanism can be used as a stator of the second driving mechanism. In order to obtain a high driving speed with a driving device having only one driving mechanism, a large driving voltage is required. However, according to the present embodiment, a high driving speed can be obtained as a whole even when the voltages for driving the rotor of the first driving mechanism and the second driving mechanism are decreased to suppress the driving speed of the individual driving mechanisms to a low value.

### Application Example 2

This application example of the invention is directed to a relative driving device including a first driving mechanism and a second driving mechanism, including: a stator; a first rotor; and a second rotor, wherein the stator includes a first electromagnetic coil and a first control unit that controls current supplied to the first electromagnetic coil, wherein the first rotor includes a magnet, wherein the second rotor includes a second electromagnetic coil and a second control unit that controls current supplied to the second electromagnetic coil, wherein the first electromagnetic coil is disposed so as to face one polarity side of the magnet, and the first electromagnetic coil and the magnet form the first driving mechanism, and wherein the second electromagnetic coil is disposed so as to face the other polarity side of the magnet, and the second electromagnetic coil and the magnet form the second driving mechanism.

According to this application example, a relative driving device can be configured so that one driving device includes the first and second driving mechanisms. Moreover, it is possible to decrease the size of the relative driving device. Furthermore, it is possible to obtain a high driving speed as a whole while suppressing the driving speed of the individual driving mechanisms to a low value.

### Application Example 3

This application example of the invention is directed to the relative driving device of Application Example 1 or 2, wherein the relative driving device has a same-speed drive mode in which current is supplied to the first electromagnetic coil to rotate the first rotor in a first direction, and holding current is supplied to the second electromagnetic coil to rotate the second rotor in the first direction in relation to the first stator at the same speed as the first rotor.

According to this configuration, the first and second rotors can be driven at the same speed.

### Application Example 4

This application example of the invention is directed to the relative driving device of Application Example 1 or 2, wherein the relative driving device has a high-speed drive mode in which current is supplied to the first electromagnetic coil to rotate the first rotor in a first direction, and current is supplied to the second electromagnetic coil to rotate the second rotor in the first direction in relation to the first stator at a higher speed than the first rotor.

According to this configuration, it is possible to drive the second rotor at a higher speed under the same driving voltage as compared to a driving device having only one driving mechanism.

### Application Example 5

This application example of the invention is directed to the relative driving device of Application Example 1 or 2, wherein the relative driving device has a low-speed drive mode in which current is supplied to the first electromagnetic coil to rotate the first rotor in a first direction, and current is regenerated from the second electromagnetic coil to rotate the second rotor in the first direction in relation to the first stator at a lower speed than the first rotor, or a stationary mode in which the second rotor is stopped in relation to the stator.

According to this configuration, it is possible to regenerate electrical energy from the second driving mechanism.

### Application Example 6

This application example of the invention is directed to the relative driving device of any of Application Examples 1 to 5, wherein the stator further includes a first noncontact power transceiving unit that includes a first transceiving coil, the second rotor further includes a second noncontact power transceiving unit that includes a second transceiving coil, and between the first noncontact power transceiving unit and the second noncontact power transceiving unit, power for driving the second electromagnetic coil or electrical energy regenerated from the second electromagnetic coil is transmitted and received by electromagnetic coupling between the first and second transceiving coils.

When an electromagnetic coil is present in a rotor, driving power for the electromagnetic coil is transmitted by a brush and a commutator. In this case, abrasion may occur in the brush and the commutator due to mechanical friction between the brush and the commutator. In contrast, according to this configuration, since there is no mechanical contact, there is no fear of abrasion and durability can be improved.

### Application Example 7

This application example of the invention is directed to the relative driving device of Application Example 6, wherein the first noncontact power transceiving unit further includes a modulation circuit that modulates a control signal for controlling the magnitude and direction of current supplied to the second electromagnetic coil with power transmitted to the second noncontact power transceiving unit, and the second noncontact power transceiving unit further includes a demodulation circuit for demodulating the control signal modulated with the power.

According to this configuration, it is possible to omit wirings for transmitting the control signal.

### Application Example 8

This application example of the invention is directed to a moving vehicle including the relative driving device of any of Application Examples 1 to 7.

### Application Example 9

This application example of the invention is directed to a robot including the relative driving device of any of Application Examples 1 to 7.

The invention can be realized in various embodiments, and for example, in addition to the relative driving device, the invention can be embodied as a robot, a robot hand, and the like using the relative driving device.

### BRIEF DESCRIPTION OF THE DRAWINGS

The invention will be described with reference to the accompanying drawings, wherein like numbers reference like elements.

FIG. 1A is a diagram schematically illustrating the configuration of a driving device according to a first embodiment.

FIG. 1B is a diagram illustrating the cross section in a direction vertical to the driving shaft of the driving device according to the first embodiment.

FIG. 1C is a diagram illustrating a first electromagnetic coil of a stator according to the first embodiment, showing an exploded view of the cylindrical surface of the stator.

FIG. 2 is a diagram schematically illustrating the block configuration of the driving device according to the first embodiment.

FIG. 3A is a diagram illustrating the operation of the driving device in a same-speed mode.

FIG. 3B is a diagram illustrating torque-rotation speed characteristics and torque-current characteristics of a first driving mechanism during the same-speed mode.

FIG. 4A is a diagram illustrating the operation of the driving device in a high-speed mode wherein the rotation speed of a first rotor is higher than the rotation speed of a second rotor.

FIG. 4B is a diagram illustrating torque-rotation speed characteristics and torque-current characteristics of the first and second driving mechanisms during the high-speed mode.

FIG. 5 is a diagram illustrating the operation of the driving device in a regeneration mode.

FIG. 6A is a diagram schematically illustrating the configuration of a driving device according to a second embodiment.

FIG. 6B is a diagram illustrating the cross section in a direction vertical to the driving shaft of the driving device according to the second embodiment.

FIG. 7A is a diagram schematically illustrating the configuration of a driving device according to a third embodiment.

FIG. 7B is a diagram illustrating an arrangement of electromagnetic coils.

FIG. 7C is a diagram illustrating an arrangement of permanent magnets.

FIG. 8 is a diagram schematically illustrating the configuration of a driving device according to a fourth embodiment.

FIG. 9 is a diagram schematically illustrating the configuration of a driving device according to a fifth embodiment.

FIG. 10 is a diagram illustrating the configuration of a wireless power transmission circuit.

FIGS. 11A to 11E are diagrams illustrating an example of a control unit of any one of the above embodiments.

FIG. 12 is a diagram illustrating the internal configuration and the operation of the control unit.

FIG. 13 is a timing chart showing the operation of a PWM unit when the first driving mechanism rotates in a normal direction.

FIG. 14 is a timing chart showing the operation of a PWM unit when the first driving mechanism rotates in a reverse direction.

FIGS. 15A and 15B are diagrams illustrating the internal configuration and the operation of an excitation period setting unit.

FIG. 16 is a diagram illustrating the operation and the timing chart of an encoding unit.

FIG. 17 is a diagram illustrating the operation state of a driving unit.

FIG. 18 is a diagram illustrating an example of a regeneration circuit.

FIG. 19 is a diagram illustrating an electric bicycle (electric-assisted bicycle) as an example of a moving vehicle which uses a motor and power generator according to a modified example of the invention.

FIG. 20 is a diagram illustrating an example of a robot which uses a motor according to a modified example of the invention.

FIG. 21 is a diagram illustrating a railroad vehicle which uses a motor according to a modified example of the invention.

### DESCRIPTION OF EXEMPLARY EMBODIMENTS

### First Embodiment

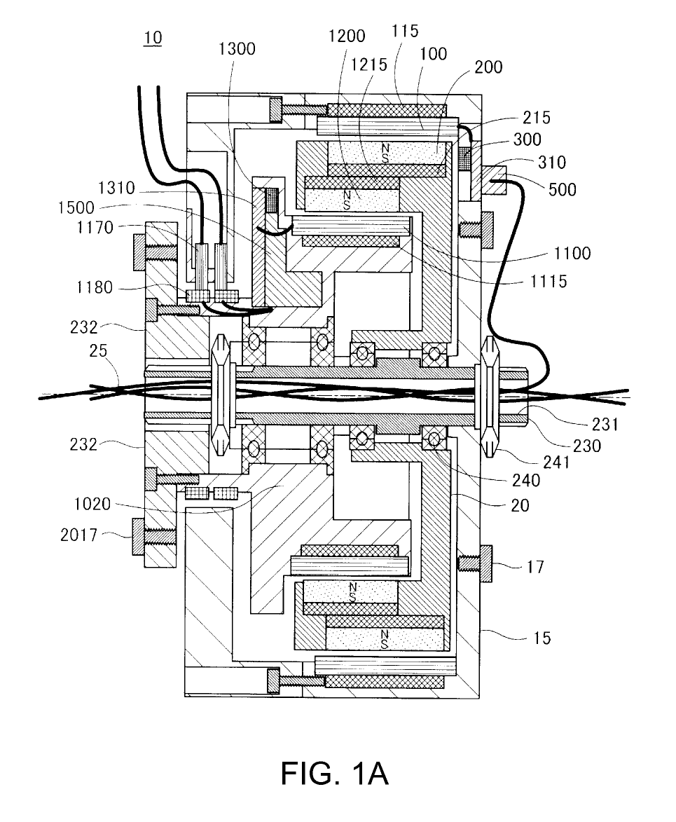

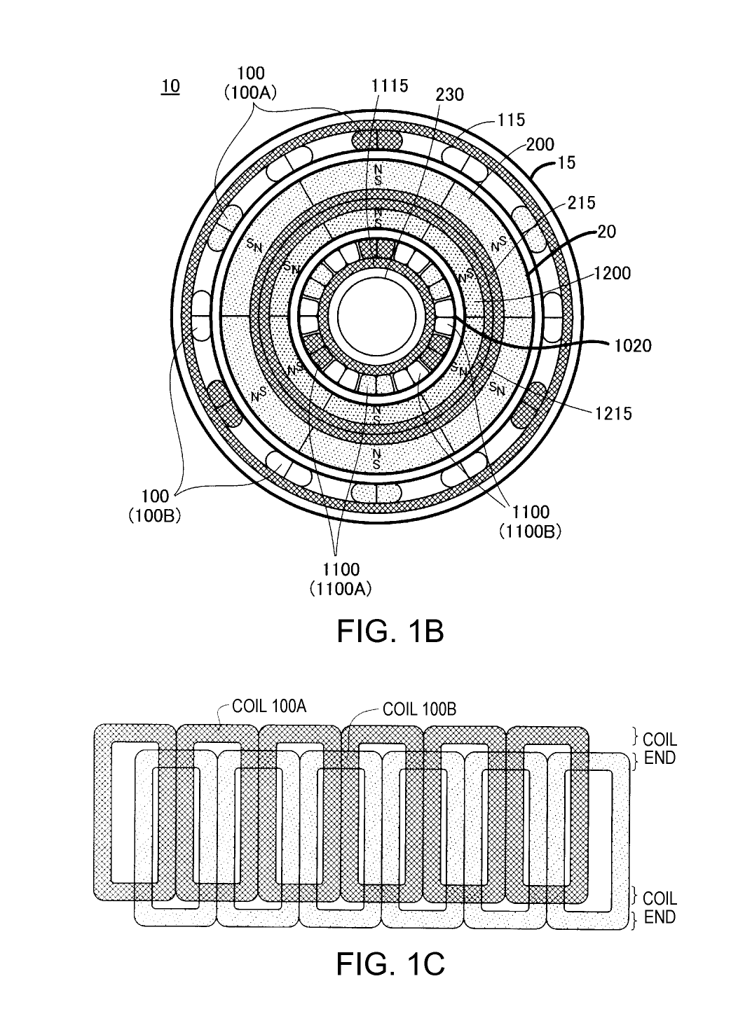

FIG. 1A is a diagram schematically illustrating the configuration of a driving device according to the first embodiment. FIG. 1B is a diagram illustrating the cross section in a direction vertical to the driving shaft of the driving device according to the first embodiment. FIG. 1C is a diagram illustrating a first electromagnetic coil of a stator according to the first embodiment, showing an exploded view of the cylindrical surface of the stator. A driving device 10 includes a stator 15, a first rotor 20, a second rotor 1020, and a central shaft 230. The stator 15 includes a first electromagnetic coil 100, a first coil back yoke 115, a first magnetic sensor 300, a first circuit substrate 310, a motor drive control unit 500, an attachment bolt 17, and a brush 1170. The first rotor 20 includes a first permanent magnet 200, a first magnet back yoke 215, a second permanent magnet 1200, and a second magnet back yoke 1215. The second rotor 1020 includes a second electromagnetic coil 1100, a second coil back yoke 1115, a second magnetic sensor 1300, a second circuit substrate 1310, a motor drive and regeneration control unit 1500, an output unit 232, a commutator 1180, and an attachment bolt 2017.

The stator 15 includes a cylindrical portion and a disk-shaped portion. A plurality of first electromagnetic coils 100 is disposed in the cylindrical portion of the stator 15 along the cylindrical surface as shown in FIGS. 1B and 1C. The first electromagnetic coils 100 include two kinds of electromagnetic coils which are A-phase electromagnetic coils 100A and B-phase electromagnetic coils 100B, which are arranged alternately along the circumference. The A-phase electromagnetic coils 100A and the B-phase electromagnetic coils 100B will be simply referred to as “electromagnetic coils 100” when they are not distinguished from each other. Each of the plurality of first electromagnetic coils 100 is wound around a line normal to the cylindrical surface. That is, the direction of magnetic flux generated when current flows in the first electromagnetic coils 100 is the radial direction or the central direction of the cylinder. The first coil back yoke 115 is disposed in a cylindrical shape on the outer side of a cylindrical surface formed by the first electromagnetic coils 100. The first coil back yoke 115 is preferably disposed so as to overlap the first electromagnetic coils 100 excluding the coil ends thereof as shown in FIG. 1C. The coil end is a portion of an electromagnetic coil on which force acts in a direction different from the circumferential direction of the cylinder when the Lorentz force acts on the electromagnetic coil 100, that is, a portion on which force acts in a direction unrelated to the rotational force of the driving device 10. The reason why the first coil back yoke 115 is disposed so as to overlap the first electromagnetic coils 100 excluding the coil ends thereof is to cause the magnetic flux generated by the permanent magnet 200 disposed in the first rotor 20 to concentrate on the portions of the first electromagnetic coils 100 excluding the coil ends thereof. Moreover, the first coil back yoke 115 is preferably formed by stacking hollow disks in a cylindrical shape. By doing so, it is possible to suppress generation of heat due to eddy-current loss. Moreover, hollow disks may be divided in order to improve processing properties. Although the first permanent magnets 200 and the second permanent magnets 1200 shown in FIGS. 1A and 1B are described to have the same number of polarities, they may have different numbers of polarities. Moreover, although the first electromagnetic coils 100 and the second electromagnetic coils 1100 shown in FIGS. 1A and 1B are described as having the same number of phases and polarities, they may have different numbers of phases and polarities.

As shown in FIG. 1A, the first magnetic sensor 300, the first circuit substrate 310, the motor drive control unit 500, and the attachment bolt 17 are disposed in the stator 15. The first magnetic sensor 300 is disposed next to the first permanent magnets 200 so as to output a sensor signal corresponding to the magnetic fluxes from the first permanent magnets 200. The first magnetic sensor 300 is preferably disposed so that the sensor signal at that time has a waveform similar to a waveform that is normalized based on the induced voltage from the first electromagnetic coils 100. As the first magnetic sensor 300, a hall sensor can be used, for example. The first magnetic sensor 300 preferably has a temperature compensation circuit capable of compensating a change in the output of the sensor signal in relation to a change in the temperature of the first magnetic sensor 300. The first magnetic sensor 300 is disposed on the first circuit substrate 310. Although the first magnetic sensor 300 also includes two kinds of magnetic sensor which are an A-phase magnetic sensor and a B-phase magnetic sensor, they are not distinguished from each other in this example. The motor drive control unit 500 is also disposed on the first circuit substrate 310. The motor drive control unit 500 may be provided outside the driving device 10.

The first permanent magnets 200 are disposed on the inner circumferential surface of the first rotor 20 so as to face an effective length of the first electromagnetic coils 100 of the stator 15 excluding the coil ends thereof. A number of first permanent magnets 200 are provided so as to correspond to the number of polarities, and the respective first permanent magnets 200 are arranged along the outer circumference of the first rotor 20. The directions of magnetic fluxes generated by the first permanent magnets 200 are the inner circumferential direction and the outer circumferential direction of the cylindrical shape, and the direction of magnetization may be a parallel direction or an axial direction. The directions of magnetic fluxes generated by the adjacent first permanent magnets 200 are opposite to each other. The first magnet back yoke 215 is disposed on the inner side of the first permanent magnet 200. The first magnet back yoke 215 has a cylindrical shape. Moreover, when the magnetization of the first permanent magnets 200 exhibits polar anisotropy, the first magnet back yoke 215 may not be provided.

A first driving mechanism includes the first electromagnetic coils 100 and the first permanent magnets 200 of the first rotor 20. The motor drive control unit 500 of the stator 15 controls the operation of the first driving mechanism by controlling the current flowing in the first electromagnetic coils 100.

The second magnet back yoke 1215 is disposed on the inner circumferential side of the first magnet back yoke 215 of the first rotor 20. The second magnet back yoke 1215 has a cylindrical shape. The second permanent magnet 1200 is disposed on the inner circumferential side of the second magnet back yoke 1215. A number of second permanent magnets 1200 are provided so as to correspond to the number of polarities, and the respective second permanent magnets 1200 are arranged along the inner circumference of the first rotor 20. The directions of magnetic fluxes generated by the second permanent magnets 1200 are the inner circumferential direction and the outer circumferential direction of the cylindrical shape, and the direction of magnetization may be a parallel direction or an axial direction. The directions of the magnetic fluxes generated by the adjacent second permanent magnets 1200 are opposite to each other.

A number of second electromagnetic coils 1100 corresponding to the number of polarities of the second permanent magnets 1200 are arranged on the outer circumferential surface of the second rotor 1020 along the outer circumferential direction of the second rotor 1020 so as to face the second permanent magnets 1200 of the first rotor 20. Similarly to the first electromagnetic coil 100, the second electromagnetic coils 1100 include A-phase electromagnetic coils 1100A and B-phase electromagnetic coils 1100B, and will be simply referred to as “electromagnetic coils 1100” when they are not distinguished from each other. Each of the plurality of second electromagnetic coils 1100 is wound around a line normal to the cylindrical surface. That is, the direction of magnetic flux generated when current flows in the second electromagnetic coils 1100 is the inner circumferential direction or the outer circumferential direction. The second coil back yoke 1115 is disposed in a cylindrical shape on the inner side of a cylindrical surface formed by the second electromagnetic coils 1100. The second coil back yoke 1115 is preferably disposed so as to overlap the second electromagnetic coils 1100 excluding the coil ends thereof. Moreover, when the magnetization of the second permanent magnets 1200 exhibits polar anisotropy, the second magnet back yoke 1215 may not be provided.

The second magnetic sensor 1300, the second circuit substrate 1310, the motor drive and regeneration control unit 1500, and the output unit 232 are disposed on the disk-shaped portion of the second rotor 1020. The second magnetic sensor 1300 is disposed next to the second permanent magnets 1200 so as to output a sensor signal corresponding to the magnetic fluxes from the second permanent magnets 1200. The second magnetic sensor 1300 is preferably disposed so that the sensor signal at that time has a waveform similar to a waveform that is normalized based on the induced voltage from the second electromagnetic coils 1100. As the second magnetic sensor 1300, a hall sensor can be used, for example, similarly to the first magnetic sensor 300. The second magnetic sensor 1300 may have a temperature compensation circuit capable of compensating a change in the output of the sensor signal in relation to a change in the temperature of the second magnetic sensor 1300. The second magnetic sensor 1300 is disposed on the second circuit substrate 1310. Although the second magnetic sensor 1300 also includes two kinds of magnetic sensors which is an A-phase magnetic sensor and a B-phase magnetic sensor, they are not distinguished from each other in this example. The motor drive and regeneration control unit 1500 is also disposed on the second circuit substrate 1310. The output unit 232 serves as the output of the driving device 10 and includes an attachment bolt 2017 for connecting a load.

A second driving mechanism includes the second electromagnetic coils 1100 and the second permanent magnets 1200 of the first rotor 20. The motor drive and regeneration control unit 1500 of the second rotor 1020 controls the operation of the second driving mechanism by controlling the current flowing in the second electromagnetic coils 1100 as a driving or regeneration current. Moreover, the motor drive and regeneration control unit 1500 operates the second driving mechanism as a power generator, and a first rotational motion (P1=ω1×τ1) of the first rotor 20 obtained by the first driving mechanism can be transmitted to the output unit 232 as a rotational motion (P2=ω2×τ2) through the second permanent magnets 1200 and the second electromagnetic coils 1100. Moreover, the electrical energy regenerated from the second electromagnetic coils 1100 can be regenerated by the motor drive and regeneration control unit 1500.

The commutator 1180 is formed in the output unit 232. The commutator 1180 is in contact with the brush 1170 formed in the stator 15. Current flowing in the second electromagnetic coils 1100 is supplied to the commutator 1180, and during the regeneration operation, the commutator 1180 is used for taking out the regeneration current serving as the electrical energy from the second electromagnetic coils 1100. Since the direction of current applied to the electromagnetic coils is generally changed in a motor in which the electromagnetic coils rotate, the commutator has the function of a rectifier, and a notch is formed in two positions of the commutator. In contrast, the commutator 1180 of the present embodiment is formed to be continuous along the circumference of the output unit 232, and a notch for switching the polarity of the current is not formed. The direction of current flowing in the second electromagnetic coils 1100 is switched by the motor drive and regeneration control unit 1500 based on the sensor signal from the second magnetic sensor 1300.

A bearing 240 is disposed between the first rotor 20 and the central shaft 230 and between the second rotor 1020 and the central shaft 230. That is, in the present embodiment, the central shaft 230 does not receive torque from the first rotor 20 or the second rotor 1020. Moreover, a thread is formed on an end portion of the central shaft 230, and a bearing ring 241 for improving the holding properties of the central shaft 230 is attached to the outer side of the stator 15 by screwing. Furthermore, a hollow 231 is formed inside the central shaft 230, and wirings for supplying power to the motor drive control unit 500 and wirings 25 used as input/output wirings of a control signal pass through the hollow 231.

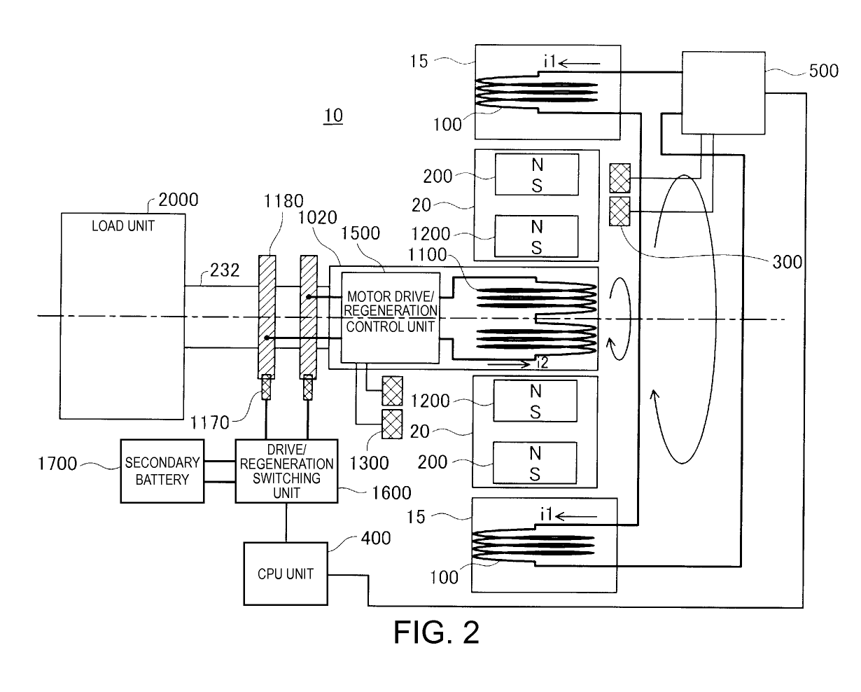

FIG. 2 is a diagram schematically illustrating the block configuration of the driving device according to the first embodiment. In FIG. 2, a CPU unit 400, a drive and regeneration switching unit 1600, a secondary battery 1700, and a load unit 2000 are illustrated in addition to the stator 15, the first and second rotors 20 and 1020, the first and second electromagnetic coils 100 and 1100, the first and second permanent magnets 200 and 1200, the motor drive control unit 500, the motor drive and regeneration control unit 1500, the output unit 232, the brush 1170, and the commutator 1180 shown in FIGS. 1A to 1C. The CPU unit 400 gives instructions on the operation of the first driving mechanism to the motor drive control unit 500 and gives instructions on the operation (driving or regeneration) of the second driving mechanism to the motor drive and regeneration control unit 1500 through the drive and regeneration switching unit 1600. The instructions on the operation of the second driving mechanism can be supplied via an instruction signal superimposed on power. The drive and regeneration switching unit 1600 switches whether the second driving mechanism will perform a driving operation or a regeneration operation. The secondary battery 1700 is connected to the drive and regeneration switching unit 1600, and the secondary battery 1700 stores regeneration power. The load unit 2000 is attached to the output unit 232. That is, the stator 15 and the central shaft 230 are fixed, and the second rotor 1020 connected to the first rotor 20 and the output unit 232 rotates along the outer circumference of the fixed central shaft 230.

The driving device 10 can execute three operation modes of a same-speed mode, a high-speed mode, and a regeneration mode in accordance with the instructions from the CPU unit 400. In the same-speed mode, the driving device 10 rotates the first and second rotors 20 and 1020 at the same speed in relation to the stator 15. In the high-speed mode, the driving device 10 rotates the first rotor 20 in a first direction in relation to the stator 15 and rotates the second rotor 1020 in a first direction in relation to the first rotor 20. That is, the rotation speed of the second rotor 1020 in relation to the first rotor 20 is added to the rotation speed of the first rotor 20, whereby the second rotor 1020 is rotated at a high speed in relation to the stator 15. In the regeneration mode, the driving device 10 rotates the first rotor 20 in a first direction in relation to the stator 15 and rotates the second rotor 1020 in a first direction in relation to the stator 15 at a lower speed than the rotation speed of the first rotor 20, so that at least a part of the energy applied to the first rotor 20 is regenerated. The respective operation modes will be described.

### (1) Same-Speed Mode

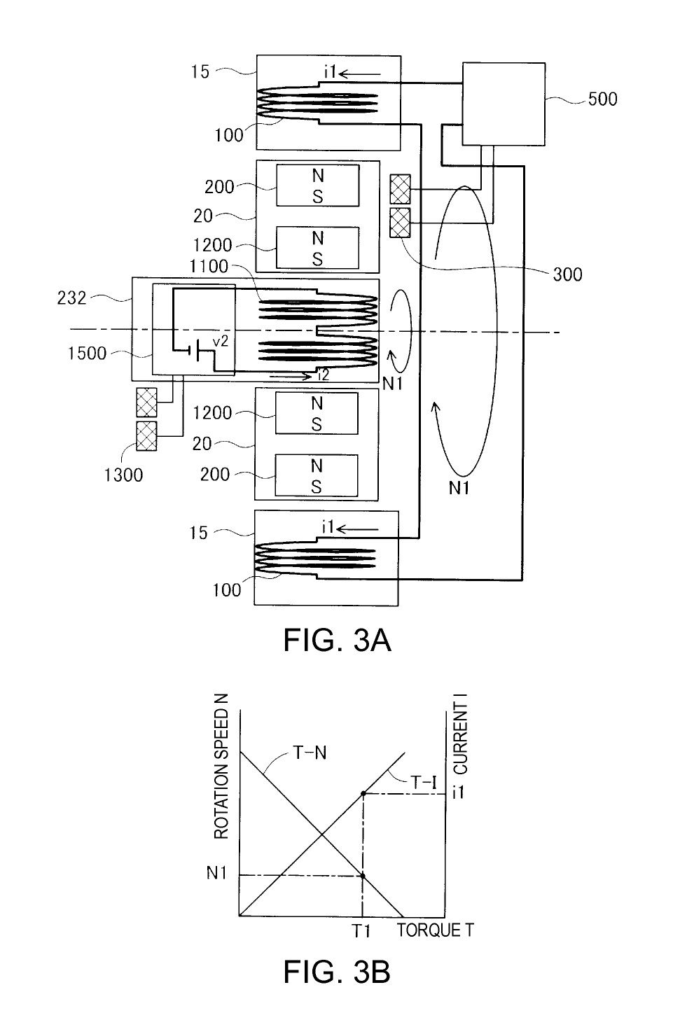

FIG. 3A is a diagram illustrating the operation of the driving device in the same-speed mode. In the same-speed mode, current i1 flows in the first electromagnetic coils 100 based on the sensor signal of the first magnetic sensor 300, whereby the first rotor 20 is rotated at a rotation speed of N1 in relation to the stator 15. Moreover, in the same-speed mode, a voltage v2 is applied to the second electromagnetic coils 1100 based on the sensor signal of the second magnetic sensor 1300 to cause holding current i2 to flow in the second electromagnetic coils 1100, whereby the second rotor 1020 is rotated at a relative rotation speed of 0 in relation to the first rotor 20. That is, the output unit 232 connected to the second rotor 1020 is rotated at a rotation speed of N1 in relation to the stator 15.

FIG. 3B is a diagram illustrating torque-rotation speed characteristics and torque-current characteristics of a first driving mechanism during the same-speed mode. In the first driving mechanism, when a load torque is T1, the first rotor 20 rotates at a rotation speed of N1 in relation to the stator 15. The current flowing in the first electromagnetic coils 100 is i1.

When the motor drive control unit 500 applies driving current to the first electromagnetic coils 100 based on the sensor signal of the first magnetic sensor 300, the first rotor 20 rotates in relation to the stator 15 and the second rotor 1020. In this case, since the second permanent magnets 1200 of the first rotor 20 moves in relation to the second electromagnetic coil 1100 of the second rotor 1020, induced electromotive force is generated in the second electromagnetic coils 1100. The motor drive and regeneration control unit 1500 drives the second electromagnetic coils 1100 based on the sensor signal of the second magnetic sensor 1300 so as to cancel the induced electromotive force, whereby the second rotor 1020 starts rotating from a non-rotating state to the rotation speed N1 following the first rotor 20. If no loss occurs, the second rotor 1020 rotates at the same speed as the first rotor 20. However, a Joule heat loss associated with a copper loss, an iron loss, and a mechanical loss occurs in the second electromagnetic coils 1100. Thus, by supplying current corresponding to the Joule heat loss of the second electromagnetic coil 1100 to the second electromagnetic coils 1100, it is possible to rotate the first and second rotors 20 and 1020 at the same rotation speed in relation to the stator 15. Current supplied in order to compensate for the electrical energy corresponding to the Joule heat loss of the second electromagnetic coils 1100 will be referred to as holding current. The holding current depends on the rotation speeds of the first and second rotors 20 and 1020.

### (2) High-Speed Mode

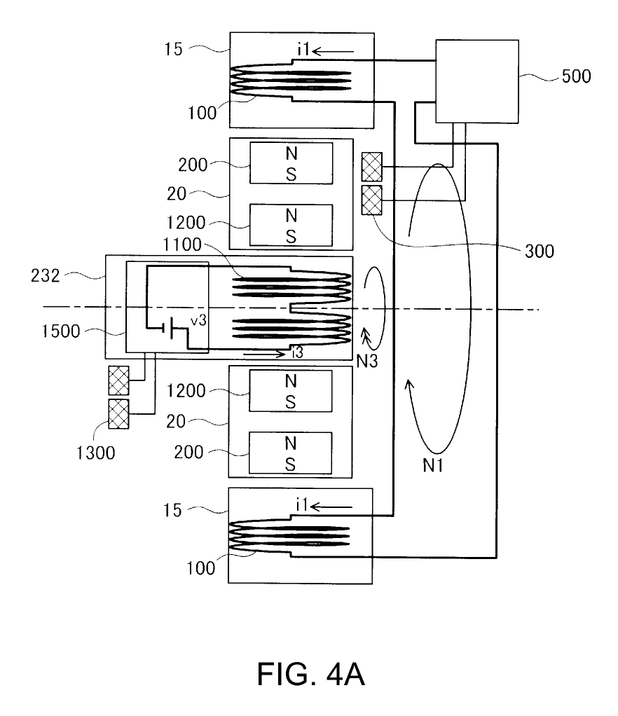

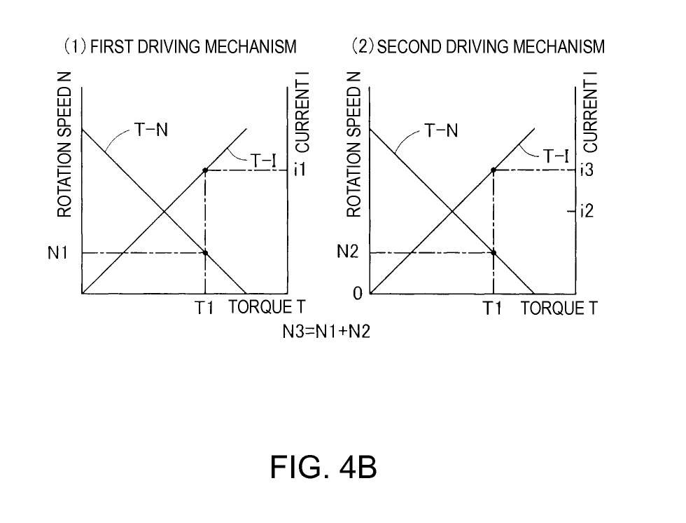

FIG. 4A is a diagram illustrating the operation of the driving device in a high-speed mode wherein the rotation speed N1 of the first rotor 20 is higher than the rotation speed N3 of the second rotor 1020. The operation of the first driving mechanism in the high-speed mode is the same as that in the same-speed mode. That is, current i1 flows in the first electromagnetic coils 100, and the first rotor 20 is rotated at a rotation speed of N1 in relation to the stator 15. In the high-speed mode, a voltage v3 (v3>v2) is applied to the second electromagnetic coils 1100 to supply current i3 larger than the holding current i2 to the second electromagnetic coils 1100, whereby the second rotor 1020 is rotated at a high speed in relation to the first rotor 20. When the rotation speed of the second rotor 1020 in relation to the stator 15 is N3, N3>N1.

FIG. 4B is a diagram illustrating torque-rotation speed characteristics and torque-current characteristics of the first and second driving mechanisms during the high-speed mode. The characteristics of the first driving mechanism shown in FIG. 4B(1) are the same as the characteristics in the same-speed mode. FIG. 4B(2) illustrates torque-rotation speed characteristics and torque-current characteristics of the second driving mechanism. Since the first driving mechanism shares the first rotor 20 with the second driving mechanism, the load torque applied to the first driving mechanism has the same magnitude as the load torque applied to the second driving mechanism. The magnitude of the load torque will be assumed to be T1. When the load torque is T1, in the high-speed mode, the second rotor 1020 rotates at a relative rotation speed of N2 in relation to the first rotor 20. Thus, a difference in rotation speed of N1+N2=N3 occurs between the stator 15 and the second rotor 1020. In this case, the current flowing in the second electromagnetic coils 1100 is i3 (i3>i2). Although the rotation speed can be increased up to N1 if there is only the first driving mechanism, since the second driving mechanism is also provided, it is possible to increase the rotation speed up to N3 (N3>N1) in accordance with the purpose.

### (3) Regeneration Mode (Neutral Mode, Low-Speed Mode, Stationary Mode)

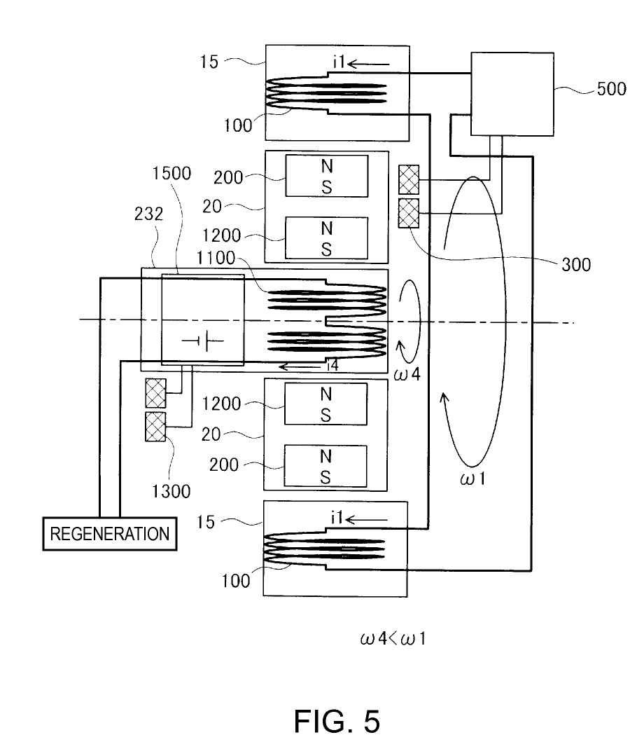

FIG. 5 is a diagram illustrating the operation of the driving device in a regeneration mode. In the regeneration mode, the second rotor 1200 where the permanent magnets 1200 are disposed is rotated by the electrical energy applied to the first driving mechanism, and induced electromotive force is generated in the second electromagnetic coils 1100 of the second rotor 1020 which are electromagnetically coupled to the permanent magnets 1200 disposed in the first rotor 20 using a part of the rotational motion of the first rotor 20. The induced electromotive force is current-controlled by the motor drive and regeneration control unit 1500 based on the second magnetic sensor 1300, whereby the rotational motion is transmitted to the output unit 232 through the second rotor 1020. By this current control, the output unit 232 can be operated in a neutral mode, a low-speed mode, and a stationary mode.

First, the neutral mode is realized by causing the motor drive and regeneration control unit 1500 so as not to supply current with respect to the induced electromotive force generated between the second electromagnetic coils 1100 in a state where the rotation speed of the first rotor 20 has no effect on the second rotor 1020.

The low-speed mode is realized by causing the motor drive and regeneration control unit 1500 so as to supply current with respect to the induced electromotive force generated between the second electromagnetic coils 1100 in a state where the torque corresponding to a part of the first rotational motion is transmitted to the second rotor 1020 as a rotational motion at a lower rotation speed than the rotation speed of the first rotor 20. By linearly controlling the amount of supplied current, the amount of torque corresponding to the amount of current can be changed linearly, and mechanical transmission can be realized easily. The current supplied at that time can also be stored at the outside as electrical energy and used as regeneration power (by a power generator).

The stationary mode is realized by causing the motor drive and regeneration control unit 1500 to supply as much current as possible with respect to the induced electromotive force generated between the second electromagnetic coils 1100 in the low-speed mode. This state is realized by causing the motor drive and regeneration control unit 1500 to supply short-circuit current with respect to the induced electromotive force generated between the second electromagnetic coils 1100 in a state where the torque corresponding to the entire part of the first rotational motion of the first rotor 20 is transmitted to the second rotor 1020 as a rotational motion. The transmission of max torque can be performed easily with the amount of supplied current. The current supplied at that time can also be stored at the outside as electrical energy and used as regeneration power (by a power generator).

In a single driving device in which there is only one driving mechanism, it is necessary to increase the voltage applied to electromagnetic coils in order to increase the rotation speed with respect to the same load torque. In contrast, according to the driving device of the present embodiment, since the rotation speed N3 of the driving device in the high-speed mode becomes a rotation speed which is an addition of the rotation speed N2 of the second driving mechanism to the rotation speed N1 of the first driving mechanism, a higher rotation speed can be achieved with the same driving voltage. Moreover, since it is possible to decrease the voltage applied to the electromagnetic coils 100 and 1100, it is possible to decrease the charge and discharge current of a parasitic capacitor of the electromagnetic coils 100 and 1100 and suppress a loss associated with the charge and discharge current.

Moreover, in the present embodiment, as described in the regeneration mode, it is possible to regenerate electrical energy using the second driving mechanism as a power generator. Moreover, when there is only one driving mechanism, since a high torque is applied when starting the driving device, abrupt acceleration is likely to occur. In the present embodiment, since the second driving mechanism gradually transitions from the regeneration mode to the same-speed mode and the high-speed mode by operating the first driving mechanism, the output unit 232 can start smoothly and accelerate smoothly. That is, by more finely controlling the neutral mode, the low-speed mode, and the stationary mode, it is possible to use the driving device as a noncontact and continuously variable transmission system in which the rotational motion can be transmitted from the first driving mechanism to the second driving mechanism in a noncontact and continuously variable manner. Moreover, by connecting the output unit 232 to a load such as a wheel, and a propeller, it is possible to greatly develop an electric vehicle.

### Second Embodiment

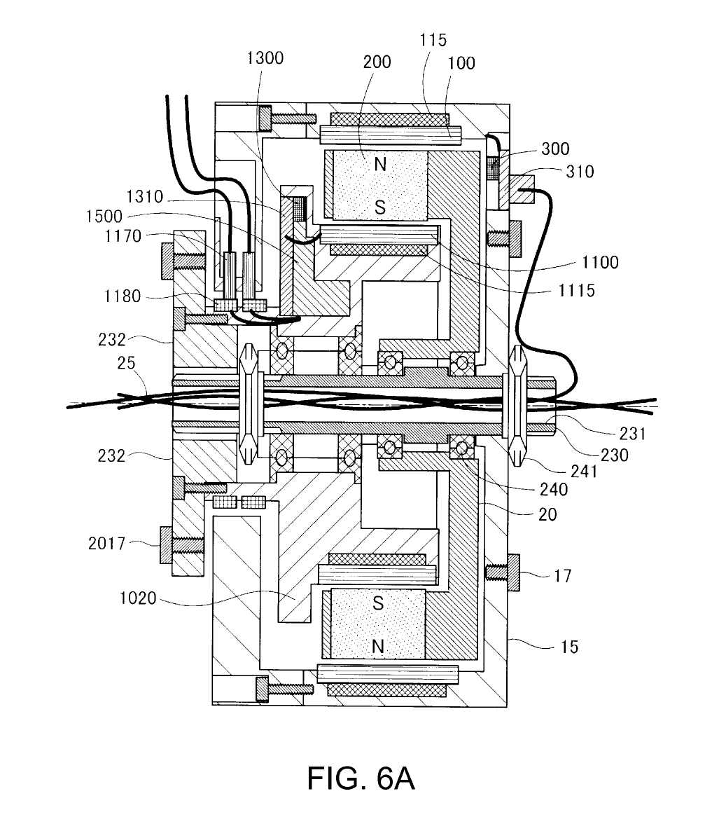

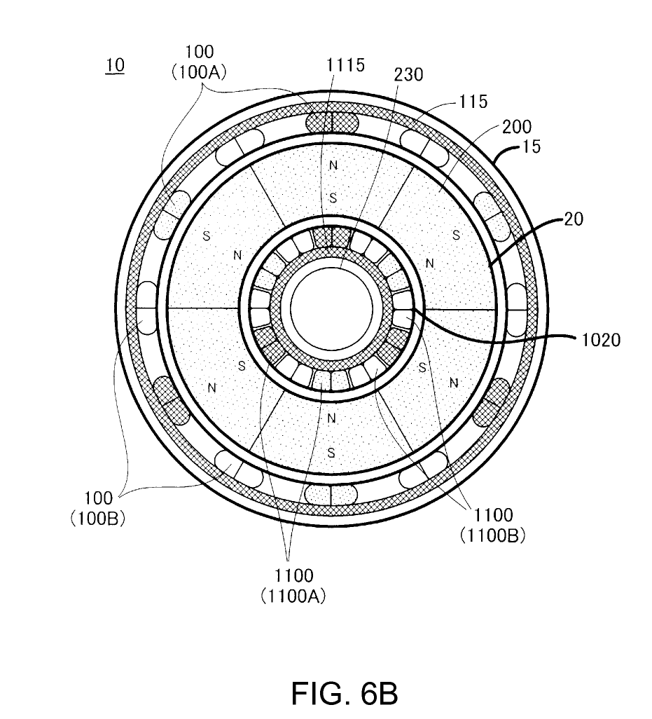

FIG. 6A is a diagram schematically illustrating the configuration of a driving device according to the second embodiment. FIG. 6B is a diagram illustrating the cross section in a direction vertical to the driving shaft of the driving device according to the second embodiment. The driving device of the second embodiment is different from the driving device of the first embodiment in that the first rotor 20 has a different configuration. That is, in the second embodiment, the first rotor 20 does not have the first and second magnet back yokes 215 and 1215 of the first rotor 20 of the first embodiment, and the first permanent magnets 200 are integrated with the second permanent magnets 1200. The permanent magnets are denoted by permanent magnets 200.

In the second embodiment, the driving device can execute the same-speed mode, the high-speed mode, and the regeneration mode similarly to the first embodiment. Moreover, in the second embodiment, since the first permanent magnets 200 are integrated with the second permanent magnets 1200, it is possible to realize a further reduction in the size and weight of the driving device than that of the first embodiment. Furthermore, in the second embodiment, the magnet back yokes 215 and 1215 can be omitted.

### Third Embodiment

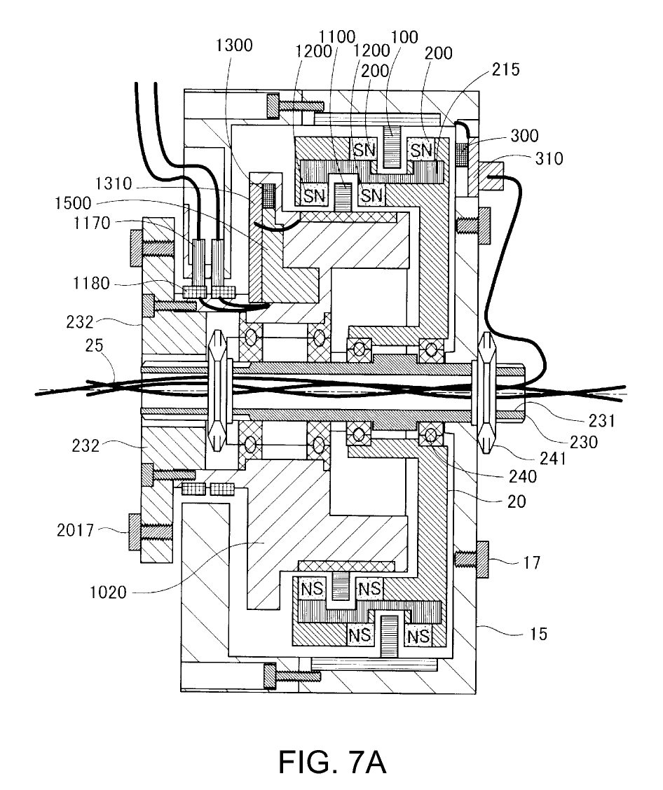

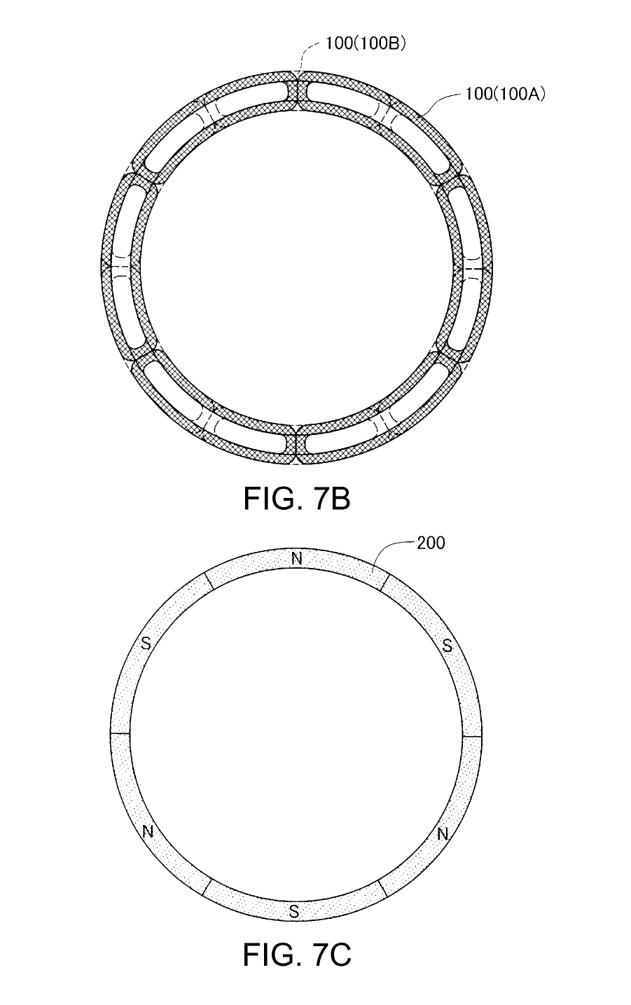

FIG. 7A is a diagram schematically illustrating the configuration of a driving device according to the third embodiment. FIG. 7B is a diagram illustrating an arrangement of electromagnetic coils. FIG. 7C is a diagram illustrating an arrangement of permanent magnets. The driving device of the third embodiment is different from the driving device of the first embodiment in that the first and second driving mechanisms of the first embodiment are of a radial gap type, whereas the first and second driving mechanisms of the third embodiment are of an axial gap type. In the third embodiment, the first and second electromagnetic coils 100 and 1100 are also made up of a plurality of electromagnetic coils 100 and 1100 in which the directions of magnetic fluxes generated when current is supplied thereto are parallel to the central shaft 230, and each of the electromagnetic coils 100 and 1100 is arranged along the circumference of the disk as shown in FIG. 7B. In the third embodiment, the first and second permanent magnets 200 and 1200 are made up of a plurality of permanent magnets 200 and 1200 in which the directions of magnetic fluxes are parallel to the central shaft 230, and each of the permanent magnets 200 and 1200 is arranged along the circumference of the disk as shown in FIG. 7C. The second electromagnetic coils 1100 and the second permanent magnets 1200 also have the same shapes as shown in FIGS. 7B and 7C.

In the third embodiment, the driving device can execute the same-speed mode, the high-speed mode, and the regeneration mode similarly to the first embodiment. Moreover, in the third embodiment, it is easy to ensure that the first and second permanent magnets 200 and 1200 have the same shape and to ensure the first and second electromagnetic coils 100 and 1100 have the same shape. That is, it is easy to ensure the first and second driving mechanisms have the same properties.

### Fourth Embodiment

FIG. 8 is a diagram schematically illustrating the configuration of a driving device according to the fourth embodiment. In the fourth embodiment, similarly to the second embodiment in relation to the first embodiment, the permanent magnet 201 disposed in the second rotor 1020 is integrated into the permanent magnets for the first rotor 20. Permanent magnets 201 have a larger size than the permanent magnets 200 and 1200 so as to overlap both the permanent magnets 200 and 1200. The permanent magnets 200, 201, and 1200 may have the same shape, and the first and second electromagnetic coils 100 and 1100 may have the same shape.

According to the fourth embodiment, since the permanent magnets 201 of the first rotor 20 are integrated with the permanent magnets of the second rotor 1020, it is possible to realize a reduction in size and weight. Moreover, it is possible to ensure the first and second driving mechanisms have the same properties.

### Fifth Embodiment

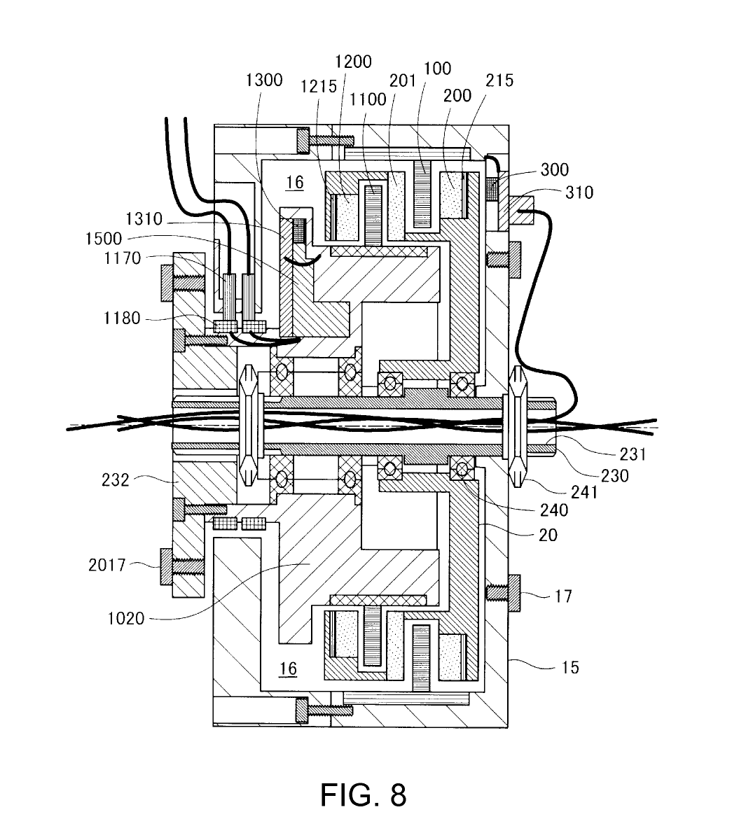

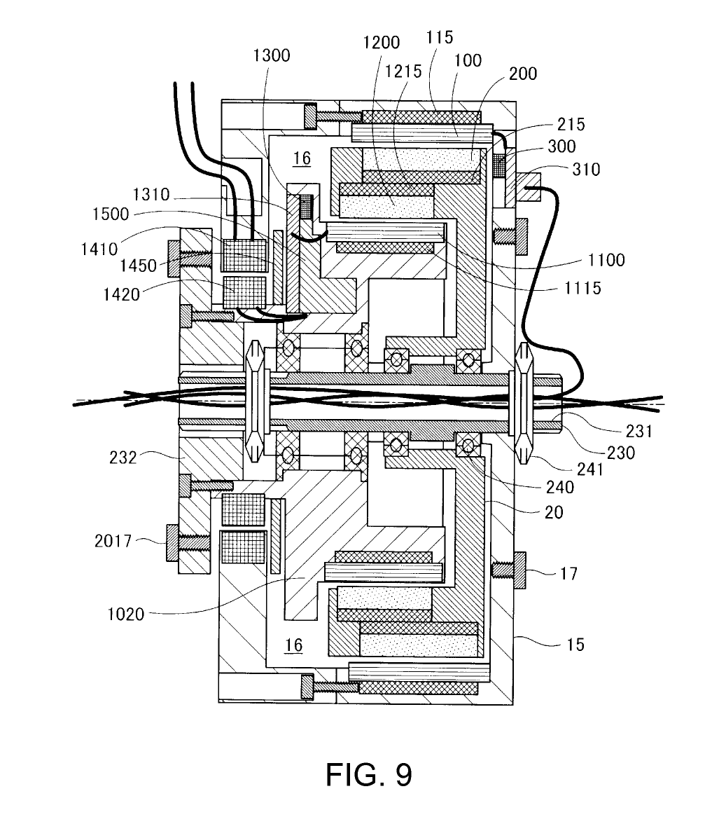

FIG. 9 is a diagram schematically illustrating the configuration of a driving device according to the fifth embodiment. The fifth embodiment is different from the first embodiment in that the current supplied to the second electromagnetic coils of the second driving mechanism are supplied in a noncontact manner. Although the first and second driving mechanisms of the fifth embodiment have the same configuration as the second embodiment, the first and second driving mechanisms may have the same configuration as any one of the first to fourth embodiments.

The stator 15 of the fifth embodiment includes a power transmission coil 1410 in place of the brush 1170, and the second rotor 1020 includes a power reception coil 1420 in place of the commutator 1180 and also includes an electromagnetic wave shielding plate 1450. That is, in the fifth embodiment, power that drives the second electromagnetic coils 1100 is transmitted using electromagnetic coupling between the power transmission coil 1410 and the power reception coil 1420. The electromagnetic wave shielding plate 1450 is disposed so that electromagnetic waves between the power transmission coil 1410 and the power reception coil 1420 do not have any adverse effect on the first and second electromagnetic coils 100 and 1100 and the first and second permanent magnets 200 and 1200.

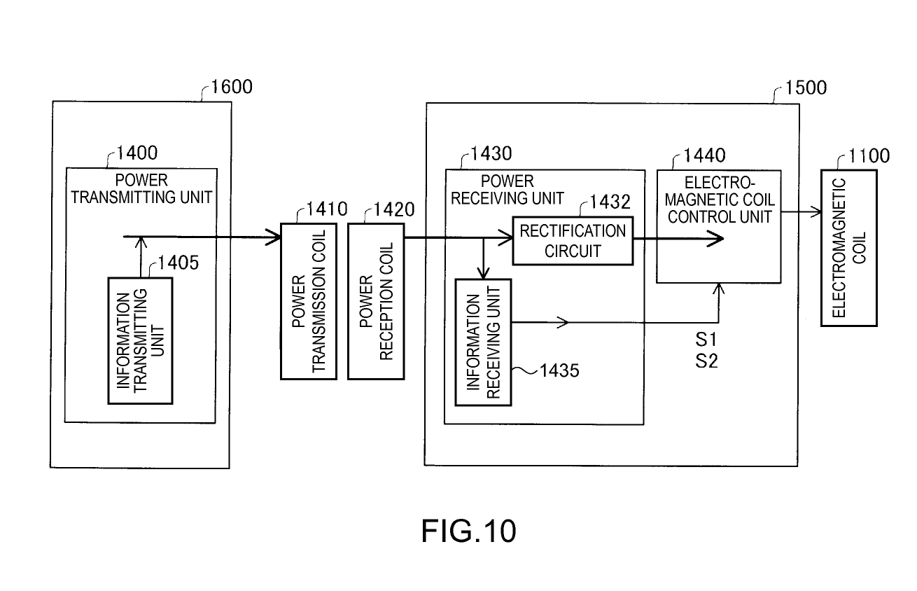

FIG. 10 is a diagram illustrating the configuration of a wireless power transmission circuit. The wireless power transmission circuit includes a power transmitting unit 1400, a power receiving unit 1430, and an electromagnetic coil control unit 1440. The power transmitting unit 1400 includes an information transmitting unit 1405. The information transmitting unit 1405 receives instructions from the CPU unit 400 shown in FIG. 2 and generates control information for determining the current to be supplied to the electromagnetic coil 1100. This control information is superimposed on a power signal. The power signal is an alternating-current signal and the control information is modulated with the power signal. As a modulation method, an amplitude modulation method, a phase modulation method, and a frequency modulation method can be used, for example. Among these methods, a phase modulation method and a frequency modulation method are preferred. Since the phase modulation method and the frequency modulation method do not change the amplitude of a signal, the amount of power will rarely change with the value of the control information. The power receiving unit 1430 includes a rectification circuit 1432 and an information receiving unit 1435. The rectification circuit 1432 converts the power signal which is an alternating-current signal into a direct-current signal. The information receiving unit 1435 demodulates the control information from the power signal to generate direction signals S1 and S2 that indicate the direction of current applied to the electromagnetic coils 1100. The electromagnetic coil control unit 1440 generates a driving signal that is applied to the electromagnetic coils 1200.

In the power transmission method using the brush 1170 and the commutator 1180 shown in FIG. 2, although abrasion of the brush 1170 or the commutator 1180 can cause a problem, such abrasion may not occur in wireless power transmission. In addition, in the case of the wireless power transmission, the roles of the power transmission coil 1410 and the power reception coil 1420 may be reversed so that the direction of the power transmission may be reversed from that during the regeneration operation.

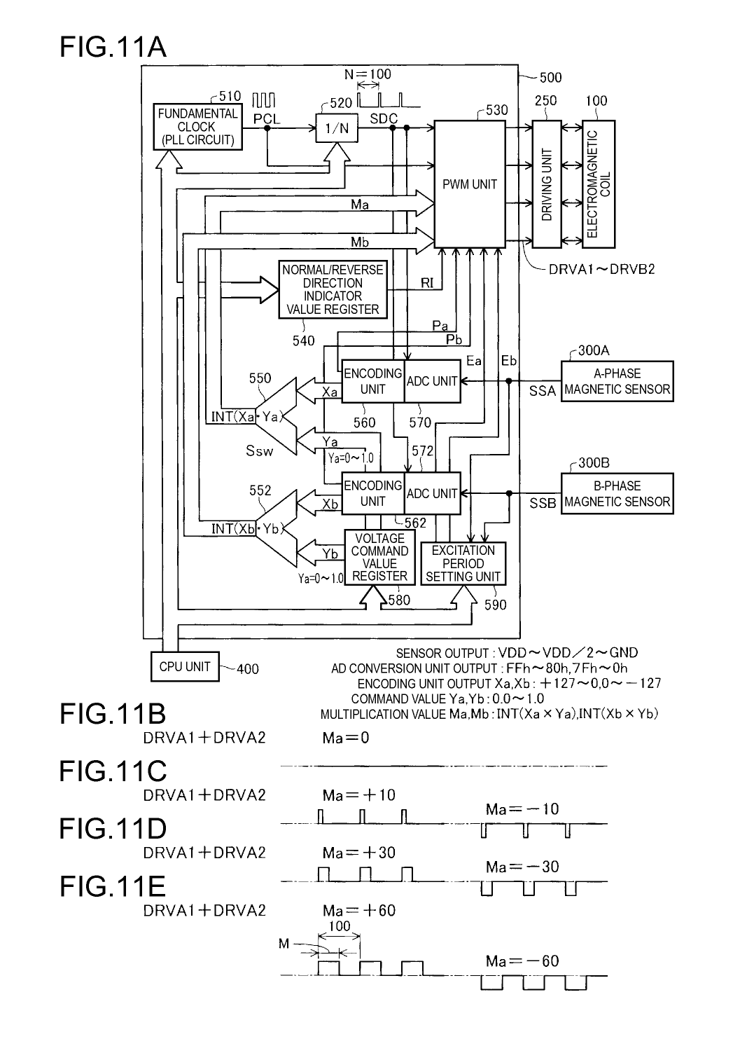

FIGS. 11A to 11E are diagrams illustrating the internal configuration and the operation of the control unit. Since the motor drive control units 500 and 1500 of the first and second driving mechanisms can employ the same circuit except for circuits associated with the regeneration function, the motor drive control unit 500 of the first driving mechanism will be described as an example, and circuits associated with the regeneration function will be described subsequently. In FIGS. 11A to 11E, the motor drive control unit 500, the driving unit 250, the electromagnetic coil 100, the first magnetic sensors 300A and 300B, and the CPU unit 400 are illustrated. The driving unit 250 is a bridge circuit including a plurality of switching elements. The motor drive control unit 500 includes a fundamental clock generation circuit 510, a 1/N frequency divider 520, a PWM unit 530, a normal/reverse direction indicator value register 540, multipliers 550 and 552, encoding units 560 and 562, AD converters 570 and 572, a voltage command value register 580, and an excitation period setting unit 590.

The fundamental clock generation circuit 510 is a circuit that generates a clock signal PCL having a predetermined frequency, and is configured by a PLL circuit, for example. The frequency divider 520 generates a clock signal SDC having a frequency corresponding to 1/N of the clock signal PCL. The value of N is set to a predetermined constant value. The value of N is set to the frequency divider 520 in advance by the CPU unit 400. The PWM unit 530 generates driving signals DRVA1, DRVA2, DRVB1, and DRVB2 based on the clock signals PCL and SDC, multiplication values Ma and Mb supplied from the multipliers 550 and 552, a normal/reverse direction indicator value RI supplied from the normal/reverse direction indicator value register 540, positive/negative sign signals Pa and Pb supplied from the encoding units 560 and 562, excitation period signals Ea and Eb supplied from the excitation period setting unit 590. This operation will be described later.

The value RI representing the rotation direction of the first driving mechanism is set by the CPU unit 400 in the normal/reverse direction indicator value register 540. In the present embodiment, the first driving mechanism rotates in a normal direction when the normal/reverse direction indicator value RI is in the L level and rotates in a reverse direction when the normal/reverse direction indicator value RI is in the H level.

The other signals Ma, Mb, Pa, Pb, Ea, and Eb supplied to the PWM unit 530 are determined as follows. The multiplier 550, the encoding unit 560, and the AD converter 570 are A-phase circuits, and the multiplier 552, the encoding unit 562, and the AD converter 572 are B-phase circuits. The operations of these circuit groups are the same, and in the following description, the operations of the A-phase circuits will be mainly described. In the following description, although the parameters (for example, an excitation period described later) of the A and B phases are described to have the same values, different values may be set to the parameters of the A and B phases.

In the present specification, when the A and B phases are illustrated without any discrimination, the letters “a” and “b” (representing the A and B phases) at the end of reference numerals are omitted. For example, when the multiplication values Ma and Mb of the A and B phases do not need to be distinguished, they will be collectively referred to as “multiplication value M”. The same is applied to the other reference numerals.

The output SSA of the magnetic sensor 300A is supplied to the AD converter 570. The output SSA of the magnetic sensor 300A ranges from GND (ground potential) to VDD (power supply voltage), and the intermediate point (=VDD/2) thereof is an intermediate point (point that passes the origin of a sinusoidal wave) of the output waveform. The AD converter 570 converts the sensor output SSA into a digital value to generate the digital value of the sensor output. The output of the AD converter 570 ranges from FFh to 0h (the suffix “h” represent that these values are hexadecimal values), for example, and the positive-side central value and the negative-side central value are set to 80h and 7Fh, respectively, so as to correspond to the intermediate points of the waveform.

The encoding unit 560 converts the range of sensor output values after AD conversion and set the value of the intermediate point of the sensor output values to “0”. As a result, the sensor output value Xa generated by the encoding unit 560 takes values in a predetermined positive-side range (for example, +127 to 0) and a predetermined negative-side range (for example, 0 to −127). However, the values supplied from the encoding unit 560 to the multiplier 550 are the absolute values of the sensor output value Xa, and the positive/negative signs thereof are supplied to the PWM unit 530 as a positive/negative sign signal Pa.

The voltage command value register 580 stores a voltage command value Ya set by the CPU unit 400. The voltage command value Ya functions as the value that sets the voltage applied to the first driving mechanism together with an excitation period signal Ea described later. Although the voltage command value Ya typically takes a value of 0 to 1.0, the voltage command value Ya may take a value greater than 1.0. However, in the following description, it is assumed that the voltage command value Ya takes a value in the range of 0 to 1.0. In this case, if a non-excitation period is not provided but the excitation period signal Ea is set so that the entire period is used as an excitation period, Ya=0 means that an applied voltage is zero, and Ya=1.0 means that an applied voltage is increased to its maximum. The multiplier 550 multiplies the sensor output value Xa output from the encoding unit 560 and the voltage command value Ya to obtain an integer sum and supplies the multiplication value Ma to the PWM unit 530.

FIGS. 11B to 11E show the operation of the PWM unit 530 when the multiplication value Ma takes various values. In this example, it is assumed that the entire period is an excitation period, and a non-excitation period is not provided. The PWM unit 530 is a circuit that generates one sequence of pulses having a duty ratio of Ma/N during one cycle period of the clock signal SDC. That is, as shown in FIGS. 11B to 11E, as the multiplication value Ma increases, the duty ratio of the pulses of the driving signals DRVA1 and DRVA2 increases. The first driving signal DRVA1 is a signal that generates pulses only when the sensor output SSA is positive, and the second driving signal DRVA2 is a signal that generates pulses only when the sensor output SSA is positive. However, these driving signals are illustrated together in FIGS. 11B to 11E. Moreover, for the sake of convenience, the second driving signal DRVA2 is illustrated as negative-side pulses.

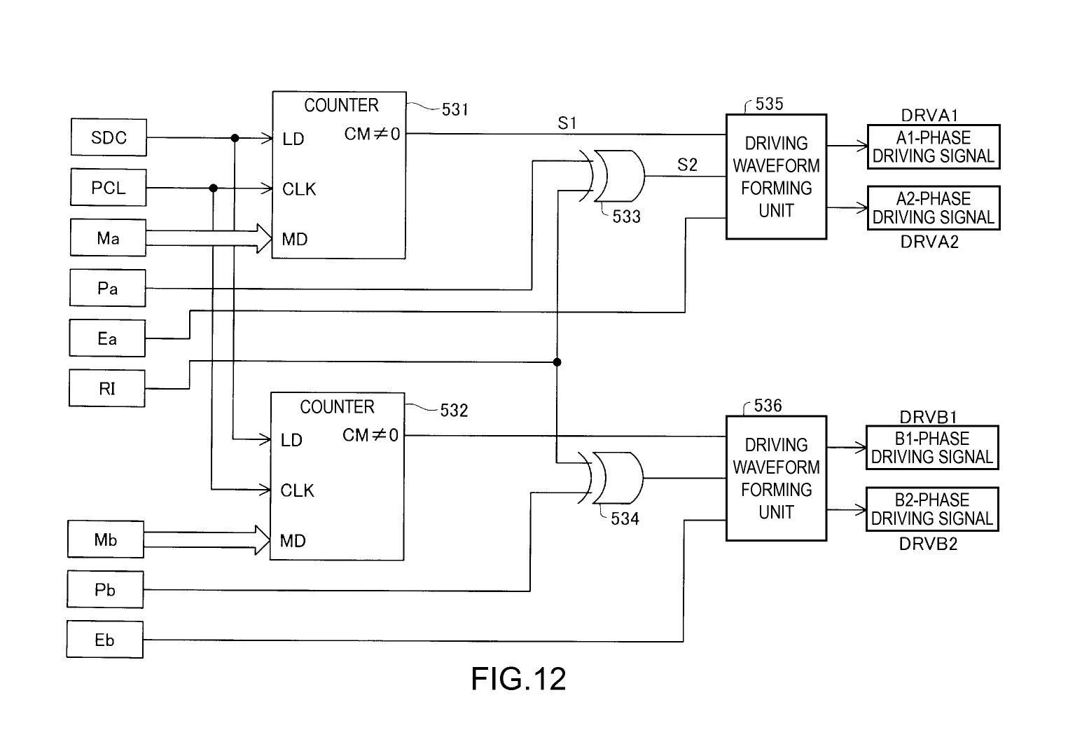

FIG. 12 is a block diagram showing an example of the internal configuration of the PWM unit 530 (see FIGS. 11A to 11E). The PWM unit 530 includes counters 531 and 532, EXOR circuits 533 and 534, and driving waveform forming units 535 and 536. The counter 531, the EXOR circuit 533, and the driving waveform forming unit 535 are circuits for the A phase, and the counter 532, the EXOR circuit 534, and the driving waveform forming unit 536 are circuits for the B phase. These elements operate as follows.

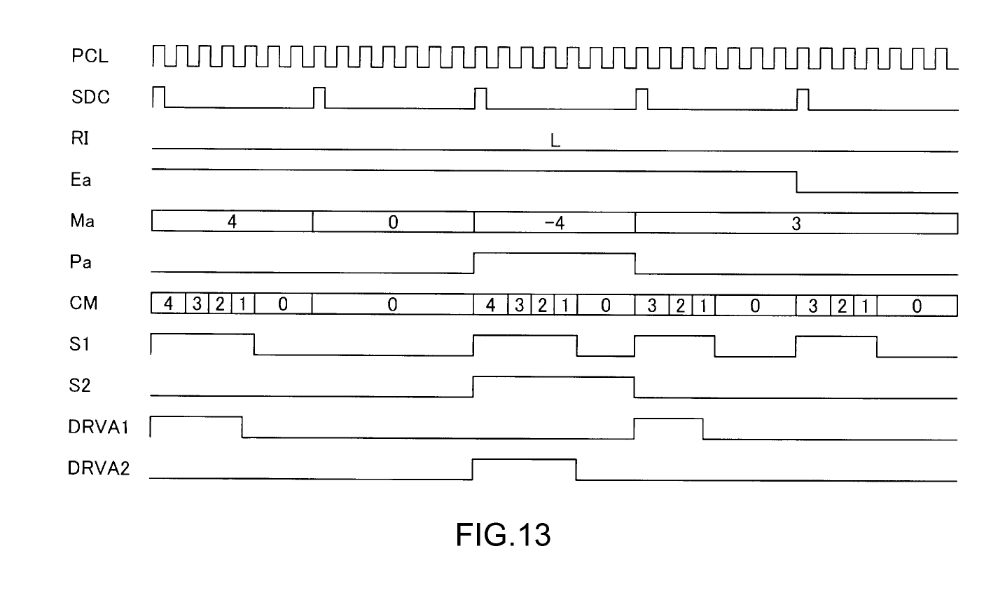

FIG. 13 is a timing chart showing the operation of the PWM unit 530 when the first driving mechanism rotates in a normal direction. In the drawing, two clock signals PCL and SDC, the normal/reverse direction indicator value RI, the excitation period signal Ea, the multiplication value Ma, the positive/negative sign signal Pa, the count value CM1 of the counter 531, the output S1 of the counter 531, the output S2 of the EXOR circuit 533, and the driving signals DRVA1 and DRVA2 which are the output of the driving waveform forming unit 535 are illustrated. The counter 531 repeats an operation of down-counting the count value CM1 up to 0 in synchronization with the clock signal PCL every cycle period of the clock signal SDC. The initial value of the count value CM1 is set to the multiplication value Ma. Although in FIG. 13, negative values are also illustrated as the multiplication value Ma for the sake of convenience, the absolute values |Ma| thereof are used by the counter 531. The output S1 of the counter 531 is set to the H level when the count value CM1 is not 0 and is changed to the L level when the count value CM1 becomes 0.

The EXOR circuit 533 outputs a signal S2 representing an exclusive logical sum between the positive/negative sign signal Pa and the normal/reverse direction indicator value RI. The normal/reverse direction indicator value RI is in the L level when the first driving mechanism rotates in the normal direction. Thus, the output S2 of the EXOR circuit 533 becomes the same signal as the positive/negative sign signal Pa. The driving waveform forming unit 535 generates the driving signals DRVA1 and DRVA2 from the output S1 of the counter 531 and the output S2 of the EXOR circuit 533. That is, the output S1 of the counter 531 when the output S2 of the EXOR circuit 533 is in the L level is output as the first driving signal DRVA1, and the output S1 of the counter 531 when the output S2 is in the H level is output as the second driving signal DRVA2. When the excitation period signal Ea changes to the L level near the right end of FIG. 13, a non-excitation period NEP is set. Thus, in the non-excitation period NEP, the driving signals DRVA1 and DRVA2 are not output, and a high impedance state is maintained.

As can be understood from the above description, the counter 531 functions as a PWM signal generation circuit that generates a PWM signal based on the multiplication value Ma. Moreover, the driving waveform forming unit 535 functions as a mask circuit that masks the PWM signal in accordance with the excitation period signal Ea.

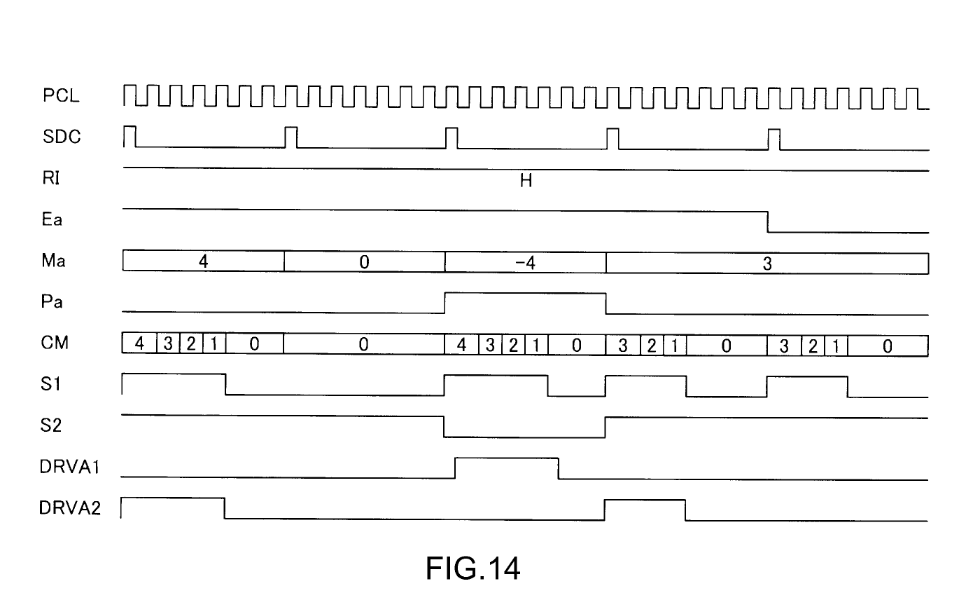

FIG. 14 is a timing chart showing the operation of the PWM unit 530 when the first driving mechanism rotates in the reverse direction. The normal/reverse direction indicator value RI is set to the H level when the first driving mechanism rotates in the reverse direction. As a result, the two driving signals DRVA1 and DRVA2 are switched from those in FIG. 13. Thus, it can be understood that the first driving mechanism rotates in the reverse direction. The B-phase circuits 532, 534, and 536 of the PWM unit 530 operate in a manner similar to the above.

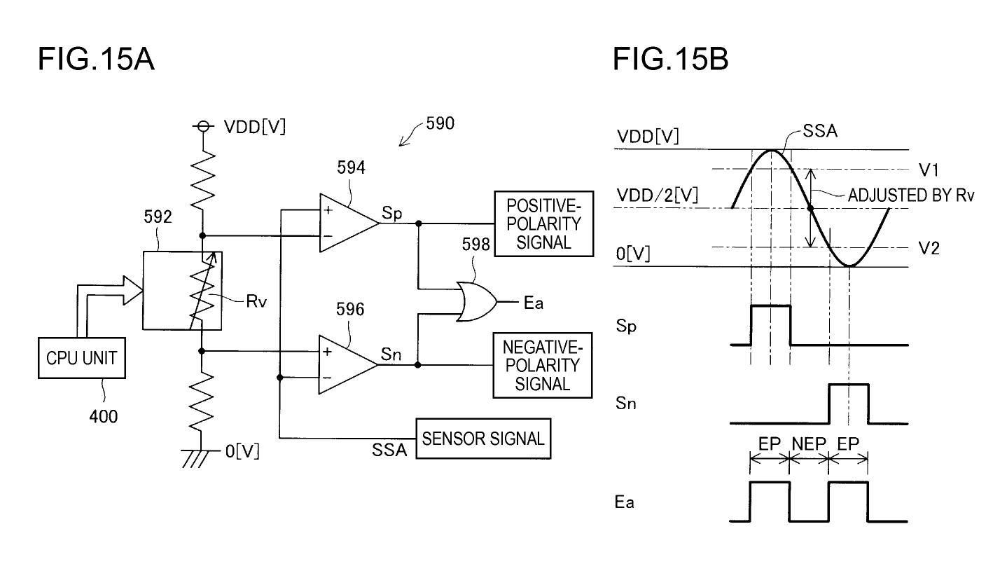

FIGS. 15A and 15B are diagrams illustrating the internal configuration and the operation of an excitation period setting unit 590. The excitation period setting unit 590 includes an electronic variable resistor 592, voltage comparators 594 and 596, an OR circuit 598, and an AND circuit 599. The resistance value Rv of the electronic variable resistor 592 is set by the CPU unit 400. The voltages V1 and V2 at both ends of the electronic variable resistor 592 are applied to one set of input terminals of the voltage comparators 594 and 596. The output SSA of the magnetic sensor 300A is supplied to the other set of input terminals of the voltage comparators 594 and 596. In FIGS. 15A and 15B, the B-phase circuits are not illustrated for the sake of convenience. The output signals Sp and Sn of the voltage comparators 594 and 596 are input to the OR circuit 598. The output of the OR circuit 598 is the excitation period signal Ea for differentiating an excitation period and a non-excitation period.

FIG. 15B shows the operation of the excitation period setting unit 590. The voltages V1 and V2 at both ends of the electronic variable resistor 592 are changed by adjusting the resistance value Rv. Specifically, the voltages V1 and V2 are set so that the differences thereof from the central value (=VDD/2) of the voltage range are the same. When the output SSA of the magnetic sensor 300A is higher than the first voltage V1, the output Sp of the first voltage comparator 594 is in the H level. On the other hand, when the output SSA of the magnetic sensor 300A is lower than the second voltage V2, the output Sn of the second voltage comparator 596 is in the H level. The excitation period signal Ea becomes a signal that takes the logical sum of the output signals Sp and Sn. Thus, as shown in the lower part of FIG. 15B, the excitation period signal Ea can be used as a signal that indicates the excitation period EP and the non-excitation period NEP. The excitation period EP and the non-excitation period NEP can be set by the CPU unit 400 adjusting the variable resistance value Rv.

The function of setting the excitation period EP and the non-excitation period NEP may be realized by other circuits other than the CPU unit 400. Moreover, the same is applied to the function of an adjustment unit that adjusts the values of both the voltage command value Ya and the excitation period signal Ea in accordance with an external request (for example, an output request from a motor) to thereby realize an output corresponding to the request.

However, when starting the driving device 10, it is preferable to set the excitation period EP as long as possible and set the non-excitation period NEP as short as possible. This is because if the driving device 10 is stopped at such a position that the phase thereof corresponds to the inside of the non-excitation period NEP, the driving device 10 may not be started since the PWM signal is masked by the driving waveform forming unit 535 (see FIG. 12). Thus, when starting the driving device 10, it is preferable to set the non-excitation period NEP to a minimum value within its allowable range. Moreover, the minimum value of the non-excitation period NEP is preferably set to a non-zero value. This is because if the minimum value of the non-excitation period NEP is set to zero, current may flow back in the driving unit 250 (see FIGS. 11A to 11E) at the point in time when the polarity (namely, the polarity of the driving signal) of the output SSA of the magnetic sensor 300A is reversed. As a result, switching transistors may be broken.

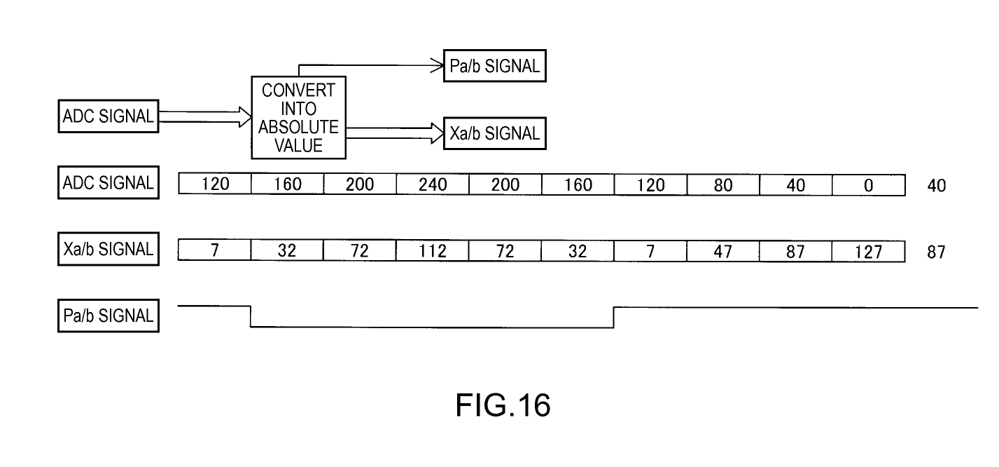

FIG. 16 is a diagram illustrating the operation and the timing chart of the encoding unit. In this example, the A-phase encoding unit 560 (see FIGS. 11A to 11E) will be described as an example. The encoding unit 560 receives an ADC signal from the ADC unit 570 (see FIGS. 11A to 11E) and generates the sensor output value Xa and the positive/negative sign signal Pa. Here, the sensor output value Xa is a value obtained by shifting the ADC signal by an amount corresponding to a value ranging from +127 to −128 and taking the absolute values thereof. Moreover, the positive/negative sign signal Pa is in the H level when the value of the ADC signal is smaller than 0, and the positive/negative sign signal Pa is in the L level when the value of the ADC signal is greater than 0. The polarities of the positive/negative sign signal Pa may be reversed.

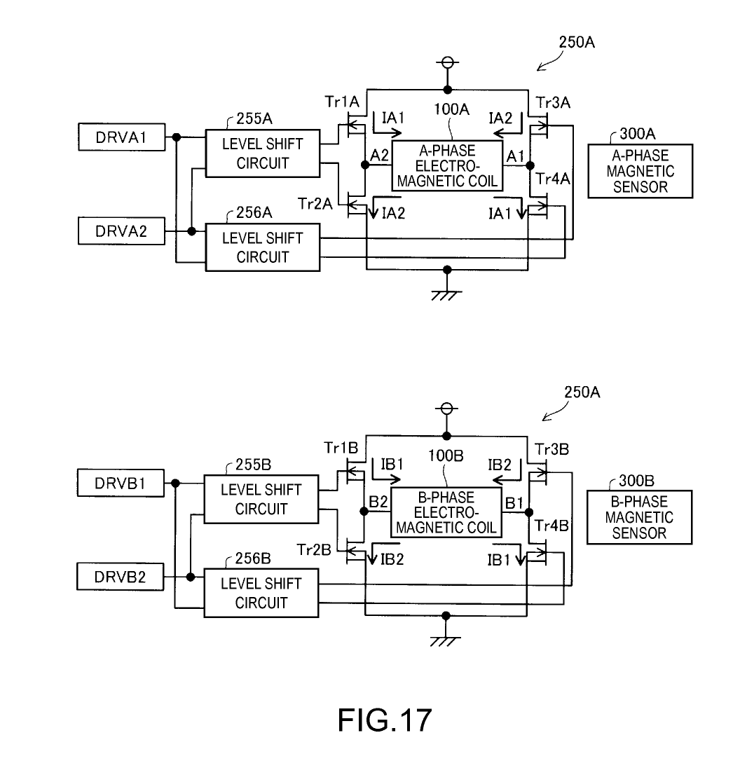

FIG. 17 is a diagram illustrating the operation state of the driving unit. Since the configuration of the A phase is the same as the configuration of the B phase, only the configuration of the A phase will be described. The A-phase driving unit 250A includes four switching transistors Tr1A to Tr4A, and level shift circuits 255A and 256A for adjusting the level of a driving signal are provided to the upper arm-side switching transistors Tr1A and Tr3A. The level shift circuits 255A and 256A may not be provided.

The A-phase driving unit 250A receives the driving signals DRVA1 and DRVA2 from the PWM unit 530 (see FIGS. 11A to 11E and FIG. 12). The driving signals DRVA1 and DRVA2 are not simultaneously turned on but only either one of them is turned on. When the driving signal DRVA1 is turned on and the driving signal DRVA2 is turned off, current flows in the first direction IA1. Conversely, when the driving signal DRVA1 is turned off and the driving signal DRVA2 is turned on, current flows in the second direction IA2. As a result, the first driving mechanism is driven in response to the driving signal.

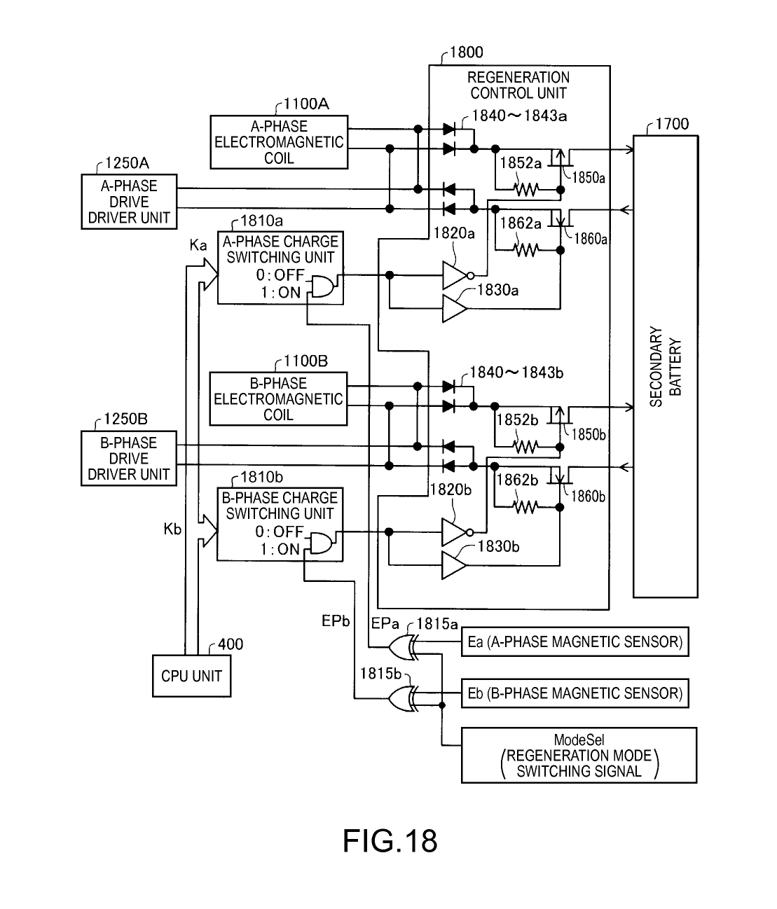

FIG. 18 is a diagram illustrating an example of the regeneration circuit. The regeneration circuit performs control of regeneration from the second driving mechanism. The regeneration circuit includes a regeneration control unit 1800, an A-phase charge switching unit 1810a, a B-phase charge switching unit 1810b, EXOR circuits 1815a and 1815b, and a secondary battery 1700. The regeneration control unit 1800 includes an A-phase regeneration control circuit 1800a and a B-phase regeneration control circuit 1800b. Since the A-phase regeneration control circuit 1800a and the B-phase regeneration control circuit 1800b have the same configuration, the A-phase regeneration control circuit 1800a will be described as an example. The A-phase regeneration control circuit 1800a is connected to the A-phase electromagnetic coil 1100A in parallel to an A-phase drive driver unit 1250A. The A-phase regeneration control unit 1800a includes an inverter circuit 1820a, a buffer circuit 1830a, rectification circuits 1840a to 1843a configured by diodes, switching transistors 1850a and 1860a, and resistors 1852a and 1862a.

When a regeneration signal Ka from the CPU unit 400 is turned on, the output of the A-phase charge switching unit 1810a is turned on. When the A-phase charge switching unit 1810a is turned on, the output of the inverter circuit 1820a is in the L state, and the switching transistor 1850a is turned on. On the other hand, since the output of the buffer circuit 1830a is in the H state, the switching transistor 1860a is turned off. In this case, the first driving mechanism can charge the secondary battery 1700 by regenerating the power generated by the A-phase electromagnetic coil 1100A through the switching transistor 1850a. Conversely, when the A-phase charge switching unit 1810a is in the off (=0=L) state, the switching transistor 1860a is turned on by the buffer circuit 1830a. On the other hand, the output of the inverter circuit 1820a is in the H state, and the switching transistor 1850a is turned off. In this case, it is possible to supply current from the secondary battery 1700 to the A-phase electromagnetic coil 1100a. There are two regeneration modes, which are switched in accordance with a regeneration mode switching signal ModeSel. As shown in FIG. 18, the output of the EXOR circuit 1815a which receives the excitation period signal Ea (see FIGS. 15A and 15B) and the regeneration mode switching signal ModeSel becomes a regeneration period EPa. The motor drive and regeneration control unit 1500 generates the regeneration mode switching signal ModeSel and switches the regeneration mode. When the regeneration mode switching signal ModeSel is in the L level, the excitation period signal Ea and the regeneration period EPa are in the same logical state. In this case, the motor drive and regeneration control unit 1500 supplies a regeneration current to areas near the points corresponding to electrical angles of π/2 and 3π/2 where an induced voltage is large. On the other hand, when the regeneration mode switching signal ModeSel is in the H state, the logical states of the excitation period signal Ea and the regeneration period EPa are opposite to each other. In this case, the motor drive and regeneration control unit 1500 supplies a regeneration current to areas near the points corresponding to electrical angles of 0 and π where an induced voltage is small. In this way, the motor drive and regeneration control unit 1500 can generate the regeneration period EPa by maintaining or inverting the logical state of the excitation period signal Ea using the regeneration mode switching signal ModeSel and gradually increase or decrease the amount of regeneration current from the points near the electrical angles of 0, π, and 2π to the points corresponding to the electrical angles of π/2 and 3π/2. Thus, it becomes easy to control a mechanical transmission torque. The same can be applied to the B phase.

As above, according to the present embodiment, it is possible to transmit first motion energy obtained by the first driving mechanism to the output unit 232 in a noncontact and linear manner as second motion energy using the second driving mechanism. Moreover, it is possible to regenerate electrical energy. The roles of the first and second driving mechanisms may be reversed, and the electrical energy can be regenerated from the first driving mechanism by driving the second driving mechanism. That is, an induced voltage is generated between the second electromagnetic coils 1100 by Fleming's right hand rule by the second permanent magnets 1200 rotated by the first rotor 20. By linearly controlling the amount of current in the coils caused by the induced voltage generated in the second electromagnetic coils 1100, it is possible to linearly transmit torque corresponding to the current to the output unit 232.

Moreover, when the motor drive and regeneration control unit 1500 supplies a voltage exceeding an induced voltage generated by the second electromagnetic coils 1100 between the second electromagnetic coils 1100 based on the output (Fleming's left hand rule) of the sensor signal of the second magnetic sensor 1300 so that the second electromagnetic coils 1100 rotate in the same direction as the second permanent magnets 1200 rotated by the first rotor 20, a rotation speed exceeding that of the first rotor 20 can be supplied to the output unit 232.

Furthermore, second motion energy obtained from the output unit 232 can be braked by a regeneration braking control (Fleming's right hand rule) of the first and second driving mechanisms and can be regenerated as electrical energy. Therefore, it is possible to provide an actuator structure in which an electric motor is integrated with a noncontact and continuously variable transmission system.

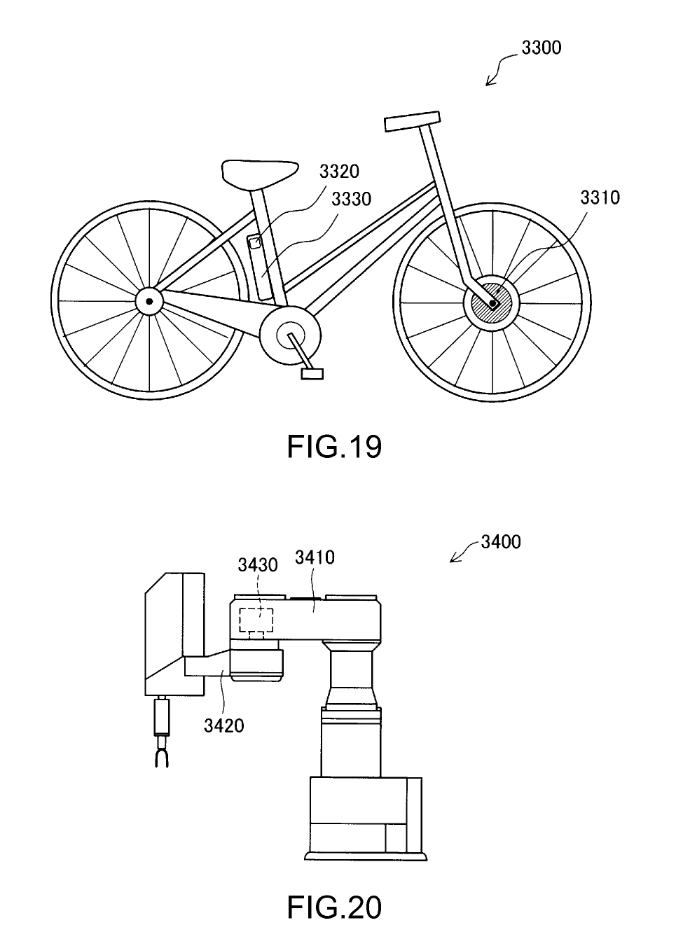

FIG. 19 is a diagram illustrating an electric bicycle (electric-assisted bicycle) as an example of a moving vehicle which uses a motor and power generator according to a modified example of the invention. This bicycle 3300 includes a motor 3310 at the front wheel, and a control circuit 3320 and a rechargeable battery 3330 both attached to the frame under the saddle. The motor 3310 drives the front wheel using the power from the rechargeable battery 3330 to assist the run. During braking, the power regenerated by the motor 3310 is charged in the battery 3330. The control circuit 3320 controls the drive and regeneration of the motor 3310. Various motors described above can be used as the motor 3310.

FIG. 20 is a diagram illustrating an example of a robot which uses a motor according to a modified example of the invention. This robot 3400 includes a first arm 3410, a second arm 3420, and a motor 3430. The motor 3430 is used to horizontally rotate the second arm 3420 as a driven member for the motor. Various motors described above can be used as the motor 3430.

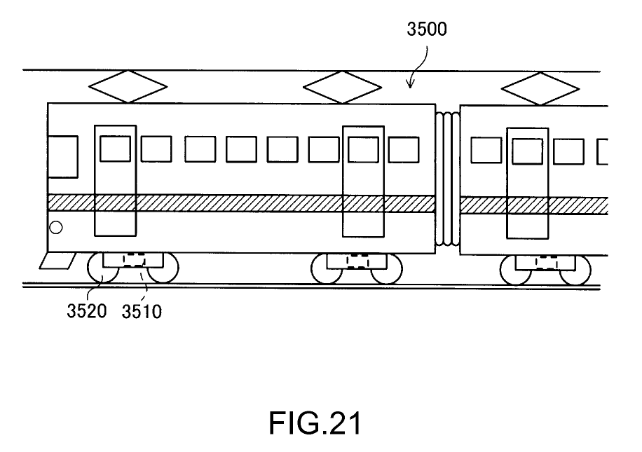

FIG. 21 is a diagram illustrating a railroad vehicle which uses a motor according to a modified example of the invention. This railroad vehicle 3500 includes a motor 3510 and a wheel 3520. The motor 3510 drives the wheel 3520. The motor 3510 is used as a power generator when braking the railroad vehicle 3500, and power is regenerated. Various motors described above can be used as the motor 3510.

Although embodiments of the invention have been described based on several embodiments, these embodiments are given not for limiting the invention but only for easy understanding of the invention. Various modifications and improvements may be made without departing from the scope and spirit of the invention, and equivalents thereof are thus encompassed by the invention.

The present application claims priority based on Japanese Patent Application No. 2011-024584 filed on Feb. 8, 2011, the disclosure of which is hereby incorporated by reference in its entirety.

What is claimed is:

1. A relative driving device including a first driving mechanism and a second driving mechanism, comprising:
a stator;
a first rotor; and
a second rotor,
wherein the stator includes a first electromagnetic coil and a first control unit that controls current supplied to the first electromagnetic coil,
wherein the first rotor includes a first magnet and a second magnet,
wherein the second rotor includes a second electromagnetic coil and a second control unit that controls current supplied to the second electromagnetic coil,
wherein the first electromagnetic coil and the first magnet are disposed so as to face each other to form the first driving mechanism, and
wherein the second electromagnetic coil and the second magnet are disposed so as to face each other to form the second driving mechanism.

2. A relative driving device including a first driving mechanism and a second driving mechanism, comprising:
a stator;
a first rotor; and
a second rotor,
wherein the stator includes a first electromagnetic coil and a first control unit that controls current supplied to the first electromagnetic coil,
wherein the first rotor includes a magnet,
wherein the second rotor includes a second electromagnetic coil and a second control unit that controls current supplied to the second electromagnetic coil,
wherein the first electromagnetic coil is disposed so as to face one polarity side of the magnet, and the first electromagnetic coil and the magnet form the first driving mechanism, and
wherein the second electromagnetic coil is disposed so as to face the other polarity side of the magnet, and the second electromagnetic coil and the magnet form the second driving mechanism.

3. The relative driving device according to claim 1,
wherein the relative driving device has a same-speed drive mode in which current is supplied to the first electromagnetic coil to rotate the first rotor in a first direction, and holding current is supplied to the second electromagnetic coil to rotate the second rotor in the first direction in relation to the first stator at the same speed as the first rotor.

4. The relative driving device according to claim 1,
wherein the relative driving device has a high-speed drive mode in which current is supplied to the first electromagnetic coil to rotate the first rotor in a first direction, and current is supplied to the second electromagnetic coil to rotate the second rotor in the first direction in relation to the first stator at a higher speed than the first rotor.

5. The relative driving device according to claim 1,
wherein the relative driving device has a low-speed drive mode in which current is supplied to the first electromagnetic coil to rotate the first rotor in a first direction, and current is regenerated from the second electromagnetic coil to rotate the second rotor in the first direction in relation to the first stator at a lower speed than the first rotor, or a stationary mode in which the second rotor is stopped in relation to the stator.

6. The relative driving device according to claim 1,
wherein the stator further includes a first noncontact power transceiving unit that includes a first transceiving coil,
wherein the second rotor further includes a second noncontact power transceiving unit that includes a second transceiving coil, and
wherein between the first noncontact power transceiving unit and the second noncontact power transceiving unit, power for driving the second electromagnetic coil or electrical energy regenerated from the second electromagnetic coil is transmitted and received by electromagnetic coupling between the first and second transceiving coils.

7. The relative driving device according to claim 6,
wherein the first noncontact power transceiving unit further includes a modulation circuit that modulates a control signal for controlling the magnitude and direction of current supplied to the second electromagnetic coil with power transmitted to the second noncontact power transceiving unit, and
wherein the second noncontact power transceiving unit further includes a demodulation circuit for demodulating the control signal modulated with the power.

8. A moving vehicle comprising the relative driving device according to claim 1.

9. A moving vehicle comprising the relative driving device according to claim 2.

10. A moving vehicle comprising the relative driving device according to claim 3.

11. A moving vehicle comprising the relative driving device according to claim 4.

12. A moving vehicle comprising the relative driving device according to claim 5.

13. A moving vehicle comprising the relative driving device according to claim 6.

14. A robot comprising the relative driving device according to claim 1.

15. A robot comprising the relative driving device according to claim 2.

16. A robot comprising the relative driving device according to claim 3.

17. A robot comprising the relative driving device according to claim 4.

18. A robot comprising the relative driving device according to claim 5.

19. A robot comprising the relative driving device according to claim 6.
